(19) United States
(12) Patent Application Publication
(10) Pub. No.: US 2024/0358029 A1
(43) Pub. Date: Oct. 31, 2024

(54) METHOD FOR PREPARING CHICKEN FRYING POWDER USING SNOW CRAB POWDER

(71) Applicant: Sang Gook JOO, Pohang-si, Gyeongsangbuk-do (KR)

(72) Inventor: Sang Gook JOO, Pohang-si, Gyeongsangbuk-do (KR)

(21) Appl. No.: 18/291,228

(22) PCT Filed: Jul. 22, 2022
(86) PCT No.: PCT/KR2022/010793

§ 371 Date: Jan. 23, 2024

(30) Foreign Application Priority Data
Aug. 20, 2021 (KR) 10-2021-0109876

(51) Int. Cl. A21D 2/34; A23L 13/50; A23L 17/10; A23L 17/40

(52) U.S. Cl. CPC A21D 2/34; A23L 13/57; A23L 17/10; A23L 17/40

(57) ABSTRACT

The present invention relates to a method for preparing a chicken frying powder using snow crab powder, more specifically to a method for preparing a chicken frying powder using snow crab powder in which snow crab powder is mixed as an ingredient of the chicken frying powder used at the time of chicken frying to have effects that the unique odor and fishy smell of chicken is removed by the snow crab powder and chitosan contained in the snow crab powder eliminates oil odor as well as makes chicken more tender.

### TECHNICAL FIELD

The present invention relates to a method for preparing a chicken frying powder that can be used as a powder for frying chicken using snow crab powder.

### BACKGROUND ART

As the demand for chicken has increased worldwide over the past 50 years, a large number of stores and recipes for fried chicken has been developed in Korea as well.

As the batter for such common fried chicken, wheat flour is used which is kneaded with water or milk and mainly used in confectionery, baking, and noodle making to be widely consumed as cookies, bread, cakes, noodles, and Sujebi (hand-pulled dough soup).

In other words, most fried chicken is made by dipping the chicken in batter to cover the outside with flour and then frying the chicken, and only some establishments provide barbecue chicken or create a new taste by further adding additional ingredients.

However, in the case of such fried chicken, when the fried chicken is prepared by dipping the chicken in batter made of general frying powder, the fishy smell or unique odor of chicken cannot be removed, and there are cases where other scents or odors coexist with the existing fishy smell of chicken, diffusing an even worse odor.

Accordingly, there is an urgent need for the development of a powder recipe that can remove the unique odor of chicken when fried chicken is prepared.

### CITATION LIST

### Patent Literature

[Patent Literature 1] Korean Patent Publication No. 10-1716387 (registered on Mar. 8, 2017)

### SUMMARY OF INVENTION

### Technical Problem

The present invention has been devised to solve the above problems, and an object of the present invention relates to a powder, which is batter covered on the surface of chicken when the chicken is fried, more specifically to a method for preparing a chicken frying powder using snow crab powder in which snow crab powder is mixed as an ingredient that constitutes the frying powder so that the unique odor and fishy smell of chicken is removed by the snow crab powder and chitosan eliminates oil odor as well as makes chicken more tender.

Other objects and advantages of the present invention will be described below and will be learned by embodiments of the present invention. Additionally, the objects and advantages of the present invention can be realized by the means and combinations indicated in the claims.

### Solution to Problem

As a means to solve the above problems, the present invention provides
a method for preparing a chicken frying powder using snow crab powder, in which, as the chicken frying powder that is covered on a surface of chicken as batter to fry the chicken, 1 kg of the chicken frying powder is mixed with 900 cc of water and used as frying paste for five chickens,
in the chicken frying powder,
20 parts by weight of refined salt, 15 parts by weight of sugar, 10 parts by weight of MSG, 3 parts by weight of turmeric powder, 5 parts by weight of white capsaicin, 5 parts by weight of baking powder, 10 parts by weight of white pepper, 10 parts by weight of garlic powder, 10 parts by weight of onion powder, 10 parts by weight of ice cream powder, 1 part by weight of guar gum, 10 parts by weight of palm oil, 10 parts by weight of soybean powder, 30 parts by weight of glutinous rice powder, 30 parts by weight of rice powder, 600 parts by weight of all-purpose flour, 200 parts by weight of corn starch, 20 parts by weight of chive powder, and 200 parts by weight of snow crab powder are mixed, and
the snow crab powder is
a powder obtained by soaking a snow crab in cold water for 2 hours to remove a salty taste of sea water, steaming the snow crab in a steamer for 30 minutes, drying the snow crab in a dryer for 48 hours, and then pulverizing the snow crab with a grinder, whereby unique odor and fishy smell of chicken is removed by the snow crab powder, and chitosan contained in the snow crab eliminates oil odor and makes chicken more tender, helping with digestion.

### Advantageous Effects of Invention

As described above, the present invention has an effect of completely removing the unique odor and fishy smell of chicken in the preparation of fried chicken.

The present invention also has an effect that chitosan contained in snow crabs eliminates oil odor and makes chicken more tender, helping with digestion when the chicken is ingested.

### DESCRIPTION OF EMBODIMENTS

Before the various embodiments of the present invention are described in detail, it will be appreciated that its application is not limited to the details of the configuration and arrangement of components described in the following detailed description or illustrated in the drawings. The present invention may be embodied and practiced in different embodiments and carried out in various ways. It will be appreciated that the expressions and predicates used herein regarding terms such as device or element direction (for example, “front”, “back”, “up”, “down”, “top”, “bottom”, “left”, “right”, and “lateral”) are used only to simplify the description of the present invention and do not necessarily indicate or imply that the associated device or element must simply have a particular direction. Terms such as “first,” “second,” and the like are used herein and in the appended claims for purposes of description and are not intended to indicate or imply relative importance or intent.

The present invention has the following features to achieve the above object.

Hereinafter, preferred embodiments of the present invention will be described in detail with reference to the attached drawings. Prior to this, terms and words used in this specification and claims should not be construed as limited to their usual or dictionary meanings, and should be interpreted with meaning and concept consistent with the technical idea of the present invention based on the principle that the inventor can appropriately define the concept of a term in order to explain his or her invention in the best way possible.

Therefore, embodiments described in this specification and the configurations illustrated in the drawings are only one of the most preferred embodiments of the present invention and do not represent the entire technical idea of the present invention, and it should be thus understood that there may be various equivalents and modifications that can replace these at the time of filing of this application.

Hereinafter, a method for preparing a chicken frying powder using snow crab powder according to a preferred embodiment of the present invention will be described in detail.

The method for preparing a chicken frying powder using snow crab powder according to the present invention is as follows.

The present invention relates to a method for preparing a chicken frying powder that is covered on the surface of chicken as batter to fry the chicken, in which
1 kg of the chicken frying powder is mixed with 900 cc of water and used as frying paste for five chickens,
(200 g of the chicken frying powder to be described later and 180 cc of water are used as paste for one chicken)
in this chicken frying powder,
20 parts by weight of refined salt, 15 parts by weight of sugar, 10 parts by weight of MSG (MSG for home use), 3 parts by weight of turmeric powder, 5 parts by weight of white capsaicin, 5 parts by weight of baking powder, 10 parts by weight of white pepper (white pepper), 10 parts by weight of garlic powder, 10 parts by weight of onion powder, 10 parts by weight of ice cream powder, 1 part by weight of guar gum, 10 parts by weight of palm oil, 10 parts by weight of soybean powder, 30 parts by weight of glutinous rice powder, 30 parts by weight of rice powder, 600 parts by weight of all-purpose flour, 200 parts by weight of corn starch, 20 parts by weight of chive powder, and 200 parts by weight of snow crab flour (powder) are mixed, and
the snow crab powder is
a powder obtained by soaking a snow crab in cold water for 2 hours to remove a salty taste of sea water, steaming the snow crab in a steamer for 30 minutes, drying the snow crab in a dryer for 48 hours, and then pulverizing the snow crab with a grinder, unique odor and fishy smell of chicken is removed by the snow crab powder, and chitosan contained in the snow crab eliminates oil odor and makes chicken more tender, helping with digestion.

In addition, according to various embodiments of the user,
the snow crab powder may be used as a powder by being mixed in advance with a total of 18 types of additives mentioned above in the chicken frying powder as above, but only a total of 18 types of additives mentioned above may be first mixed to prepare a powder and then only the snow crab powder may be added separately when water is added and kneading is performed. When the snow crab powder is added separately at the time of kneading in this way, there is an effect of further improving the flavor of paste.

As described above, although the present invention has been described with limited embodiments and drawings, the present invention is not limited thereto, and various modifications and changes can be made by those skilled in the art to which the present invention pertains within the scope of equivalence of the technical idea of the present invention and the scope of the claims described below of course.

1. A method for preparing a chicken frying powder using snow crab powder, wherein, as the chicken frying powder that is covered on a surface of chicken as batter to fry the chicken, 1 kg of the chicken frying powder is mixed with 900 cc of water and used as frying paste for five chickens,
in the chicken frying powder, 20 parts by weight of refined salt, 15 parts by weight of sugar, 10 parts by weight of MSG, 3 parts by weight of turmeric powder, 5 parts by weight of white capsaicin, 5 parts by weight of baking powder, 10 parts by weight of white pepper, 10 parts by weight of garlic powder, 10 parts by weight of onion powder, 10 parts by weight of ice cream powder, 1 part by weight of guar gum, 10 parts by weight of palm oil, 10 parts by weight of soybean powder, 30 parts by weight of glutinous rice powder, 30 parts by weight of rice powder, 600 parts by weight of all-purpose flour, 200 parts by weight of corn starch, 20 parts by weight of chive powder, and 200 parts by weight of snow crab powder are mixed, and
the snow crab powder is a power obtained by soaking a snow crab in cold water for 2 hours to remove a salty taste of sea water, steaming the snow crab in a steamer for 30 minutes, drying the snow crab in a dryer for 48 hours, and then pulverizing the snow crab with a grinder, thereby unique odor and fishy smell of chicken is removed by the snow crab powder, and chitosan contained in the snow crab eliminates oil odor and makes chicken more tender, helping with digestion.
